(19) United States
(12) Patent Application Publication
(10) Pub. No.: US 2006/0209628 A1
(43) Pub. Date: Sep. 21, 2006

(54) Energy delivery system

(76) Inventors: Anthony Patrick Jones, Ware (GB); Clive Adrian Smith, Harlow (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 10/552,868

(22) PCT Filed: May 19, 2004
(86) PCT No.: PCT/EP04/05495

§ 371 Date: Oct. 12, 2005

(30) Foreign Application Priority Data
May 23, 2003 (GB) 0311959.1

(51) Int. Cl. B01F 13/08

(52) U.S. Cl. 366/273

(57) ABSTRACT

An energy delivery system for delivering energy to a content in a vessel has a contactlessly-powerable energy emitting device which (i) is adapted to be positioned inside the vessel, and contactlessly-powered when inside the vessel to emit energy to the content, and (ii) has a control mechanism adapted in use to control the operation of the energy emitting device in accordance with a prescribed regime; and a power supply adapted in use to contactlessly-couple with the energy emitting device for powering thereof when inside the vessel. The device may be in the form of a stirrer. The system has particular application for use in Isothermal Power Compensation Calorimetry (IPCC).

### FIELD OF THE INVENTION

The present invention relates to an energy delivery system for delivering energy to a content in a vessel and also to a stirrer for stirring a fluid which has an energy emitting mechanism. The present invention is particularly, but not exclusively, concerned with a heating system and a stirrer which has a heating mechanism.

### BACKGROUND OF THE INVENTION

As background art there may be mentioned U.S. Pat. No. 6,149,295 (Volkmer et al/BASF AG) which discloses a stirrer for stirring the content of a reactor which is provided with a temperature sensor to allow the temperature inside the reactor to be monitored.

International patent application publication WO-A-02076595 (Avantium International B.V.) also discloses a stirrer which incorporates therein a temperature sensor to enable the temperature of a fluid contained in a vessel to be monitored while it is being stirred by the stirrer. In this case, however, the stirrer is a magnetic stirrer which is able to be rotated about its axis by a magnet drive mechanism which creates a rotating magnetic field about the vessel. Moreover, the temperature sensor is contactlessly-powered by an externally located power supply through electromagnetic induction. The sensor signals produced by the temperature sensor are transmitted over a wireless data link between the stirrer and a display unit so the real-time temperature in the vessel can be displayed on a display of the display unit.

International patent application publication WO-A-0226386 (Avantium International B.V.) discloses an integrated vessel transporter (IVT) which includes a reaction vessel adapted to hold a chemical substance and within which is located a stirrer of the type disclosed in WO-A-02076595 supra. The IVT further includes a heater in the form of a jacket about the reaction vessel. The sensor signals transmitted from the stirrer are used to control the heating effect of the heater so as to regulate the temperature in the reaction vessel. In other words, the temperature sensor forms part of a feedback control loop for controlling the operation of the heater.

### SUMMARY OF THE INVENTION

According to a first aspect of the present invention there is provided an energy delivery system for delivering energy to a content in a vessel, the system having:—

(a) a contactlessly-powerable energy emitting device which:—

(i) is adapted to be:—
   positioned inside the vessel, and
   contactlessly-powered when inside the vessel to emit energy to the content, and
(ii) has a control mechanism adapted in use to control the operation of the energy emitting device in accordance with a prescribed regime; and
   (b) a power supply adapted in use to contactlessly-couple with the energy emitting device for powering thereof when inside the vessel.

Preferably, the energy emitting device is adapted to emit energy which, in use, affects a condition of the contents. The condition may be a physical, chemical, physico-chemical or biological condition. As an example, the energy emitted by the device may result in a chemical/biological reaction or process occurring in the content and/or the yield of a specific reaction product being increased, for instance by photochemistry.

Accordingly, the control mechanism may be adapted in use to operate to vary the amount of energy emitted by the device to control the content condition affected by the energy. As an example, the control mechanism may be adapted in use to operate to control the rate of emission of the energy from the device.

Alternatively, the energy emitted by the device may be such as to be affected by a change in a condition of the content, e.g. by a change in a chemical/biological condition of the content, such as in the case of the occurrence of a reaction or a change in the composition of the content, or by a change in a physical condition of the content, such as density, pressure etc. The change in the energy effected by the change in the content condition could then be sensed by a sensor of the system for real-time monitoring of the content condition.

The energy emitting device is preferably adapted in use to emit thermal energy to the contents, i.e. it is a heating device.

Alternatively or additionally, the energy emitting device is an electromagnetic radiation emitting device which is adapted in use to emit electromagnetic radiation into the contents, e.g. optical radiation, such as visible light (e.g. blue light), infra-red radiation (IR), ultraviolet radiation (UV) etc. This would be useful where, for example, the device was intended to be used for photochemistry.

Alternatively or additionally, the energy emitting device is adapted in use to emit acoustic energy, for instance sonic energy or ultrasonic energy.

Preferably, the device is a self-contained device, more preferably dimensioned to be wholly immersible in the content. The device may be sized to fit into a vessel having a maximum internal diametral dimension of no more than about 30 mm, for instance in the range of about 20 mm to about 30 mm. Thus, the device may have a maximum outer diametral dimension of less than about 30 mm.

Preferably, the energy emitting device is comprised in a stirrer, preferably a contactlessly-drivable stirrer, such as known in the art, e.g. a magnetic stirrer. The stirrer dimension may be as mentioned previously for the device. Typically, the stirrer will have an external casing defining a sealed inner volume inside of which the energy emitting device will be located. Alternatively, the stirrer has an external casing which presents an external stirrer surface on which the energy emitting device, or an energy emitting part thereof, is mounted.

In an embodiment of the invention, such as hereinafter described, the energy emitting device is electrically-powerable and the power supply is adapted in use to contactlessly provide electrical power to the device.

In an embodiment of the invention, such as hereinafter described, the device has an electrically-powerable energy emitting element which, in use, emits energy in response to electrical current provided thereto under control of the control mechanism. The energy emitting element may be a heating element, an electromagnetic radiation emitting element, or an acoustic energy emitting element, for example. The emitting element may be comprised in a microelectronic device. Where the device is comprised in a stirrer, the emitting element may be located inside the stirrer or on the external stirrer surface.

In an embodiment of the invention, such as hereinafter described, the device and power supply are adapted to be inductively coupled for powering the device. To this end, the power supply may have an inductive electrical circuit, e.g. an electrical circuit having a coil. The inductive electrical circuit is preferably an ac electrical circuit, more preferably a rf electrical circuit, for instance having a frequency in the range of 20-100 kHz, preferably about 30 kHz. The power supply may be mains powered.

Preferably, the system of the invention further includes a base unit in which the vessel is holdable and which includes the power supply. The base unit may have a cavity for receiving the vessel. The cavity may have a base wall and a side wall and the inductive electrical circuit, in particular the coil thereof, may be located at the base wall so as to be disposed, in use, underneath the vessel. In an alternative arrangement, the coil of the inductive electrical circuit is located at the side wall so as to be disposed, in use, adjacent the side of the vessel. For instance, the coil may be wound round the side wall of the cavity.

The base unit may have a plurality of cavities, each for receiving a vessel, with the power supply being adapted to contactlessly couple with an energy emitting device in each vessel. To this end, the inductive electrical circuit may have a single coil which is adapted to inductively couple with all the energy emitting devices, or a plurality of coils, each associated with a different cavity for independent inductive coupling of the energy emitting devices. Where there are a plurality of coils, their arrangement with respect to the associated cavity may be as previously stated.

The base unit of the system may have a contactless drive mechanism for contactlessly driving the stirrer, for instance a magnetic drive mechanism.

In an embodiment of the invention, the system further includes the vessel. The vessel will preferably be a batch vessel, i.e. a vessel with a blind inner volume for the contents and an opening in fluid communication therewith. Typically, the vessel will have a closed base end, an open upper end in fluid communication with the inner volume, and a side wall extending from the closed base end to the open upper end. The inner volume and opening may be in a container part of the vessel, with the vessel further having a lid part to close the opening.

Preferably, the vessel is a batch reaction vessel adapted for chemical or biological reactions or a conduit through which, in use, a fluid flows, such as a pipe or tube. The vessel is preferably of laboratory scale, e.g. of test-tube dimensions, such as having a maximum inner diametral dimension of no more than about 30 mm, for example no more than about 20 mm.

When the device is a heating device, it may comprise a material which is adapted to be caused to heat up by induction heating by the power supply, i.e. heat-generating electrical currents are inducible in the material of the heating device by the power supply, an example being eddy currents.

In this regard, the heating device may consist of, or include, a heating member made wholly or partly from an electrically conducting material, for instance graphite or a metal etc. The heating member may comprise an insulating material, such as a polymeric material, ceramic or glass, and an electrically conducting material, for instance loaded or encased in the insulating material. In this instance, the electrically conducting material may be in powder form, e.g. nickel powder.

The heating member may be in the form of a solid block or a coil. As an example, the heating device may have a body and the heating coil is disposed inside the body or is wound round an external surface of the body, which external surface may also be an external surface of the heating device itself.

In an embodiment of the invention, such as hereinafter described, the control mechanism is able to vary the amount of energy emitted by the device, in particular the rate of energy emitted.

In an embodiment of the invention, such as hereinafter described, the control mechanism has a controller. Preferably, the controller is a programmable controller which is programmed to cause the energy emitting device to operate in accordance with the prescribed regime, e.g. by pulse width modulation. As an example, the controller may be a micro-controller, for instance an Arizona Microchip PIC12F629 or a Cygnal Integrated Products C8051F300. The on-board controller is preferably contactlessly-powerable by the power supply and may be adapted to be programmed or reprogrammed wirelessly, e.g. through a wireless data link with a remotely-located process controller.

In an embodiment of the invention, such as hereinafter described, the control mechanism is an electrical control circuit operatively coupled to the electrically-powerable energy emitting element for controlling operation thereof in accordance with the prescribed regime. Preferably, the circuit has the controller.

The electrical control circuit may be adapted to be contactlessly-coupled with the power supply for forming a contactless power transfer link, for instance by inductive coupling. As an example, the coil of the power supply circuit may be a primary coil and the electrical control circuit may have a secondary coil which, in use, is inductively coupled to the primary coil. The control circuit may form a part of the microelectronic device.

The system of the invention may further have a sensor to produce condition signals representative of a condition of the contents, preferably a condition which is changeable by the energy emitted by the energy emitting device. Preferably, the sensor is adapted in use to produce real-time condition signals. The condition signals may be electrical signals. The sensor may be an electrically-powerable sensor, for instance a microelectronic sensor. The sensor is preferably contactlessly-powerable by the power supply. Conveniently, the sensor forms a part of the energy emitting device. However, the sensor may be an independent component of the system which is reversibly receivable in the vessel.

The sensor may be a temperature sensor which produces temperature signals representative of the temperature of the contents, e.g. a thermocouple, a platinum resistance temperature sensor, a thermistor or a semiconductor temperature sensor. In this case, the temperature sensor may be adapted in use to be operatively coupled to the heating device to control the heating device so that it regulates the temperature of the contents, e.g. maintained at a predetermined or constant temperature. Thus, the system could form a part of a calorimeter, for instance an isothermal calorimeter, such as an isothermal power compensation calorimeter (IPCC).

Alternatively, the sensor may be a pH sensor, a turbidity sensor, an acoustic energy detector, or an electromagnetic radiation detector, etc.

In an embodiment of the invention, such as hereinafter described, the sensor is operatively coupled to the control mechanism such that the condition signals are inputtable to the control mechanism and the control mechanism is adapted to control the amount of energy emitted by the device in response to the condition signals to regulate the sensed condition in accordance with a prescribed regime.

The device may be adapted such that, in use, the condition signals are processed by the control mechanism to control the energy emitted by the energy emitting device in dependence of the condition signals. To this end, the control mechanism may have a data store in which is stored data representative of the prescribed regime for the sensed condition and a comparator to compare the condition signals with the stored data and to produce control signals for controlling the energy emitted by the device which account for the comparator result so that the sensed condition accords with the prescribed regime therefor. Typically, the data store and comparator will be in the controller.

In an embodiment of the invention, such as hereinafter described, the prescribed regime for the sensed condition is programmed in the controller.

In an embodiment of the invention, such as hereinafter described, the device has a regulator operable to regulate the amount of power transferred from the power supply to the electrically-powerable energy emitting element and the control mechanism is operably coupled to the regulator to cause, in use, the regulator to regulate the power transfer so that the energy emitting element emits energy in accordance with the prescribed regime.

The regulator may be operated by the control signals produced by the control mechanism. To this end, the controller of the control mechanism may be a digital controller which, in use, outputs digital control signals to the regulator.

For simplicity, the regulator may be a power-on/power-off switch for the electrically-powerable energy emitting element. The control signals then operate as switch-on or switch-off signals. To this end, the digital controller may be adapted in use to output a binary control signal to the switch, e.g. a logical-0 (or logical-1) switch-off control signal or a logical-1 (or logical-0) switch-on control signal. The switch is preferably a transistor, more preferably a field effect transistor (FET), and yet more preferably a MOSFET.

In an embodiment of the invention, such as hereinafter described, the control mechanism is adapted in use to operate to cause a continuous series of electrical pulses to be inputted to the electrically-powerable energy emitting element, the pulse durations and spacings being variable by the control mechanism to result in the energy emitted by the emitting element according with the prescribed regime. Preferably, the control mechanism is adapted to operate to control the energy emitting element by pulse width modulation (PWM). The pulses may be generated at a fixed frequency with the duty cycle being variable. The control mechanism may comprise a PWM controller. This may be realised through the control of the regulator by the control mechanism, as in the embodiment hereinafter described.

Alternatively, the regulator may be operable in use to allow power to be transferred to the energy emitting element at a plurality of discrete power-on levels, or at an infinitely variable number of power-on levels, e.g. in the case where the regulator is a variable resistor.

The device may have a transmitter for wireless transmission of operation signals, e.g. to a remote receiver, for instance in a process controller. The operation signals may be the condition signals produced by the sensor. Alternatively, or additionally, the operation signals may be signals representative of the amount of energy being emitted by the device or the power supplied to the energy emitting element. The device may have a receiver for receiving wireless control signals from an external process controller, e.g. signals for programming/reprogramming the controller. Where the device has a transmitter and a receiver, these are ideally realised in a transceiver.

The device may further have a memory store for storing data representative of the operation of the device therein and a download means for downloading the stored operation data, e.g. through the transmitter.

In an embodiment of the invention, such as hereinafter described, the content is a fluid, more particularly a liquid. For example, the fluid may be a homogeneous liquid, or a mixture of liquids, which may also contain dissolved gases. The fluid may also be a heterogeneous mixture containing suspended solids, either chemical, biological, or biochemical, in a liquid, or a mixture of liquids, The liquid may contain polystyrene beads for carrying out solid phase organic chemistry, or the beads may contain polymer supported reagents. The liquid may contain dissolved gases and/or a suspended solid.

According to a second aspect of the present invention there is provided an energy delivery system for delivering energy to a content in a vessel, the system having:—

(a) a contactlessly-powerable energy emitting device which is adapted to be:—

positioned inside the vessel, and
contactlessly-powered when inside the vessel to emit energy to the content;
   (b) a power supply adapted in use to contactlessly-couple with the energy emitting device for powering thereof when inside the vessel;
   (c) a sensor adapted in use to produce condition signals representative of a condition of the content; and
   (d) a control mechanism adapted in use to control the amount of energy emitted by the energy emitting device in accordance with a prescribed regime.

In an embodiment of the invention, such as hereinafter described, the energy is such as to affect the sensed condition and the control mechanism is adapted to (i) receive the condition signals, and (ii) vary the amount of energy emitted by the device in dependence of the condition signals to regulate the sensed condition in accordance with the prescribed regime.

The control mechanism may operate to control the amount of energy emitted by the energy emitting device by regulating the power transferred to the device, e.g. by pulse width modulation.

In an embodiment of the invention according to its second aspect, the control mechanism has a process controller which, in use, is disposed external to the vessel and is programmed with the prescribed regime.

The process controller may be operatively coupled to the power supply to regulate the power transferred thereby to the energy emitting device. For example, the process controller may be adapted in use to receive the condition signals and to regulate the power supply transfer accounting therefor, e.g. through a comparator and data store as aforesaid. The sensor may be part of the device, and the device may have a transmitter for wireless transmission of the condition signals to a receiver of the process controller.

Alternatively, the process controller may have a transmitter to wirelessly transmit control signals representative of the prescribed regime to a receiver in the energy emitting device which is operatively coupled to a regulator adapted to regulate the amount of energy emitted by the device responsive to the control signals. The control signals may be generated in dependence of the condition signals.

According to the invention there is further provided a calorimeter including the system of the invention. The calorimeter may be an isothermal calorimeter, typically an IPCC. In this event, the operation signals or data may be representative of the power output of the device during an isothermal process carried out with the calorimeter and the system has a processor unit for processing the operation signals/data to determine the occurrence of exothermal/endothermic events during the process.

The invention yet further provides a laboratory-scale reaction apparatus including the system of the invention.

The present invention also provides a stirrer for stirring a fluid having an energy emitting mechanism which is adapted to be contactlessly powered to emit energy into the fluid.

Preferably, the stirrer is a contactlessly-drivable stirrer. Typically, the stirrer is a magnetic stirrer, for instance having one or more magnetic structures adapted to co-operate with a magnetic drive mechanism for imparting a stirring motion to the stirrer.

Preferably, the energy emitting mechanism is adapted to be contactlessly-powered by electromagnetic induction.

The energy emitting mechanism may have an electrically-powerable energy emitting mechanism which is contactlessly-powerable, e.g. by induction.

The stirrer may include a control mechanism which is operatively coupled to the energy emitting mechanism for control thereof in accordance with a prescribed regime.

The control mechanism may have a programmable controller, e.g. a micro-controller, programmed to cause the energy emitting mechanism to operate in accordance with the prescribed regime. Preferably, the controller is a PWM controller.

In an embodiment of the invention, such as hereinafter described, the electrically-powerable energy emitting mechanism has an electrically-powerable energy emitting element and the control mechanism has an electrical control circuit operatively coupled to the energy emitting element to control operation thereof, e.g. by PWM. The control circuit may be adapted to be contactlessly coupled to an external power supply for forming a contactless power transfer link therewith, e.g. by having a coil for inductive coupling with an external inductive power circuit. The electrical control circuit may have the controller with the controller operatively coupled to the energy emitting element for control thereof.

The energy emitting mechanism may be a microelectronic device.

The energy emitting mechanism is preferably a heating mechanism, although it may instead be an electromagnetic radiation emitter, acoustic energy emitter supra. Thus, for example, the electrically-powerable energy emitting mechanism may be an electrically-powerable heating mechanism, e.g. with an electrically-powerable heating element.

Alternatively, the heating mechanism may be in the form of a discrete heating element which is adapted to be heated by electrical currents induced therein by electromagnetic induction, e.g. eddy currents. The heating element may be in the form of a discrete electrically-conducting coil, for instance located inside the stirrer or wound about an external surface of the stirrer.

The stirrer may further have a sensor for sensing a condition of the fluid and producing real-time condition signals representative of the condition. The sensor may be an electrically-powerable sensor, for instance a microelectronic sensor. The sensor is conveniently contactlessly-powerable by electromagnetic induction.

The stirrer may be adapted such that, in use, the energy emitting mechanism is controlled in response to the condition signals, e.g. to maintain the sensed condition in accordance with a prescribed regime. To this end, the condition signals may be input to the control mechanism, e.g. the controller or the electrical control circuit, for processing thereof to produce a control signal for controlling operation of the energy emitting mechanism.

Preferably, the control mechanism is adapted in use to control the energy emitting mechanism in response to the condition signals so that the energy emitted to the fluid is automatically regulated to maintain the fluid condition in accordance with a prescribed regime.

Preferably, the control mechanism has a regulator for regulating the power input to the energy emitting mechanism and thereby regulating the energy emitted by the energy emitting mechanism. The regulator may be a power-on/power-off switch supra. In an embodiment of the invention, such as hereinafter described, the control mechanism is adapted in use to operate to cause the regulator to provide a continuous series of electrical pulses to the electrically-powerable energy emitting element, the pulse widths and spacings being such as to cause the energy emitting element to emit energy in accordance with the prescribed regime, e.g. to regulate a condition of the content, preferably the sensed condition in which case the control mechanism is adapted in use to operate the regulator in dependence of the condition signals. The control mechanism may be adapted to cause the regulator to produce the pulse series by pulse width modulation.

Preferably, the sensor is a temperature sensor, examples of which having being given hereinabove. The control mechanism may thus be adapted in use to control the heating mechanism to maintain the fluid temperature in accordance with a prescribed temperature regime, e.g. at a constant temperature or substantially constant temperature.

The stirrer may include a transmitter for wireless transmission of the condition signals to an externally located receiver. Alternatively, or additionally, the transmitter is for transmitting operation signals representative of an operational parameter of the stirrer, for example the time-varying amount of energy emitted from the device or the time-varying amount of power provided to the electrically-powerable energy emitting element. This information is useful, for instance, where the stirrer is being used to stir a content undergoing an isothermal calorimetry process because variations in the energy/power can reveal endothermic and exothermic events in the content.

The stirrer may include a receiver for wirelessly receiving control signals from a remote process controller. The control mechanism may have the receiver and be adapted in use to control the energy emitting mechanism in response to the control signals. The control signals may be generated in response to the condition signals transmitted by the transmitter.

Where the stirrer has a transmitter and a receiver, these are ideally realised in a transceiver.

The stirrer of the invention may be adapted to float in a liquid substance, or adapted to be caused to float in a liquid substance.

For the avoidance of doubt, each aspect of the present invention may include one or more of the features of the other aspects.

Other preferred features of the present invention will be appreciated from the exemplary embodiments of the invention which will now be described with reference to the accompanying Figures of drawings.

### BRIEF DESCRIPTION OF THE FIGURES OF DRAWINGS

FIG. 1 is a schematic, part sectional view of a system according to a first embodiment of the invention comprising a base unit for receiving a reaction vessel and a magnetic stirrer receivable in the vessel and carrying an electrical heater so as to be able to control the temperature of the content in the vessel.

FIG. 2 is a schematic view of the stirrer and the means by which the stirrer is inductively powered.

FIG. 3 is a schematic view of a typical pulse width modulated electrical control signal generated by a micro-controller in the stirrer to operate a switch circuit to control the electrical heater.

FIG. 4 is a view of a first base unit in accordance with the present invention.

FIG. 5 is a view of a second base unit in accordance with the present invention.

FIG. 6 shows an alternative stirrer configuration of the present invention.

FIG. 7 is a schematic, part sectional view of a system according to a second embodiment of the present invention.

FIG. 8 is a schematic, part sectional view of a system according to a third embodiment of the present invention.

### DETAILED DESCRIPTION OF THE FIGURES OF DRAWINGS

In the various embodiments of the invention now to be described with reference to the accompanying FIGURES of drawings, like features are denoted by like reference numerals.

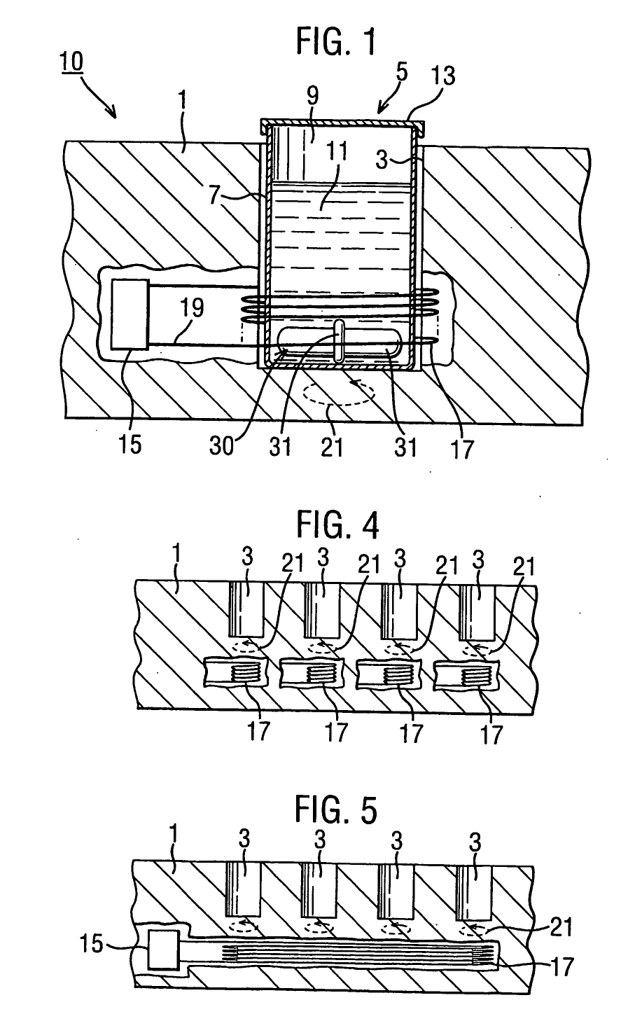

In FIG. 1 there is shown a heating system 10 in accordance with a first embodiment of the present invention. The heating system 10 forms a part of an isothermal power compensation calorimeter (IPCC). The heating system 10 comprises a base unit 1 which provides a cavity 3 in which a batch reaction vessel 5 is receivable.

The reaction vessel 5 comprises a container part 7, which defines a blind inner volume 9 in which a liquid 11 is receivable, and a lid 13 for sealing of the open end of the container 7. The base unit 1 includes a power source 15 which causes an alternating current to flow in a primary coil 17 of a primary electrical circuit 19. Moreover, the base unit 1 includes means (not shown) for producing a rotating magnetic field 21 underneath the cavity 3. The means for producing the rotating magnetic field 21 could, for example, be a rotating magnet structure or a set of electromagnets independently operable to produce the rotating magnetic field 21.

The power source 15, which may be connected to a mains power socket, supplies the alternating current to the primary coil 17 at a high frequency, such as in the range of 20-100 kHz. Typically, the frequency of the alternating current will be 30 kHz.

Immersed in the liquid substance 11 is a bar-type magnetic stirrer 30, in this embodiment having an elongate body 31 of bean-shape with a transverse rib 33 at the mid point of the body 31. The body 31 of the stirrer 30 has a plastic outer casing, e.g. of polytetrafluoroethylene (PTFE) and encloses one or more magnetic structures (not shown) which co-operate with the rotating magnetic field 21 to cause the stirrer 30 to rotate about the rib 33 on the bottom of the container 7, as known in the art.

To control the temperature of the liquid substance 11, the temperature of the base unit 1 is firstly controllable essentially isothermally at a temperature which is less than that required for the liquid substance 11, for instance about 5° C. below the required temperature for the liquid substance 11. As an example, this may be achieved by the provision of one or more passageways (not shown) in the base unit 1 through which oil from a heater/chiller unit is caused to flow.

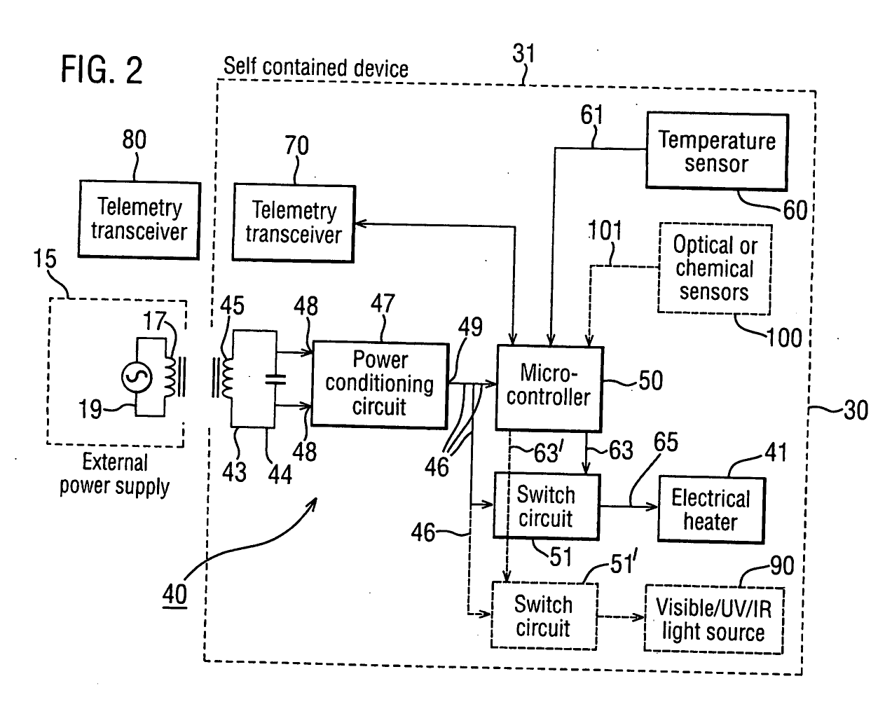

Additionally, the stirrer 30 is provided with an electrical heater as will be described in more detail with reference to FIG. 2. FIG. 2 also shows schematically the form of the external power source 15, from which it will be seen that the primary coil 17 functions as an inductor, the reason for which will shortly become apparent.

As shown in FIG. 2, the stirrer 30 contains an electrical control circuit 40 to control operation of an electrical heater 41, which in this embodiment takes the form of a resistance heater. The electrical control circuit 40 has a power receiver 43 for contactlessly receiving power from the power source 15. In other words, the receiver 43 forms a contactless power transfer link with the external power source 15. To this end, the receiver 43 in this embodiment takes the form of a secondary circuit 44 which includes a secondary induction coil 45 which couples with the primary induction coil 17 to result in an alternating electrical current being induced in the secondary circuit 44 by electromagnetic induction. The induced current is conveyed to a power conditioning circuit 47 which rectifies the alternating current input at 48 into a direct current (DC) 46 at its output 49 of fixed voltage. In this regard, the power conditioning circuit 47 can comprise a full-wave rectifier, a smoothing capacitor and, optionally, a voltage regulator, as recognised by the skilled person in the art.

The DC output 46 from the power conditioning circuit 47 is input to the power supply pins of a micro-controller 50 and a switch circuit 51.

The micro-controller 50 is a general purpose micro-controller, for example, an Arizona Microchip PIC12F629 or a Cygnal Integrated Products C8051F300. The micro-controller 50 is programmed to cause the switch circuit 51 to operate to regulate the periods at which the DC output 46 can pass through the switch circuit 51 to the electrical heater 41 so that the temperature of the liquid substance 11 is maintained constant. More particularly, the micro-controller 50 operates to control the switch circuit 51 by pulse width modulation (PMW), as will be described in more detail shortly.

The stirrer 30 further incorporates a temperature sensor 60 which is connected to the electrical control circuit 40 so that it is powered by the DC output 46. The temperature sensor 60 produces electrical sensor signals 61 representative of the temperature of the liquid substance 11 which are input to another I/O pin of the micro-controller 50 so that the electrical heater 41 can be operated under a closed-loop control. The temperature sensor 60 can take various guises, for instance it may be a thermocouple, thermister, platinum resistance sensor or a semiconductor sensor. Additional signal processing circuit elements may be required in order to interface the temperature sensor 60 with the micro-controller 50, as will be understood and implementable by the skilled person in the art.

The micro-controller 50 has a memory (not shown) in which is stored a program for controlling the electrical heater 41 so as to maintain the temperature in the liquid substance 11 constant. This may include a lookup table in which the different sensor signals 61 produced for different temperatures are recorded.

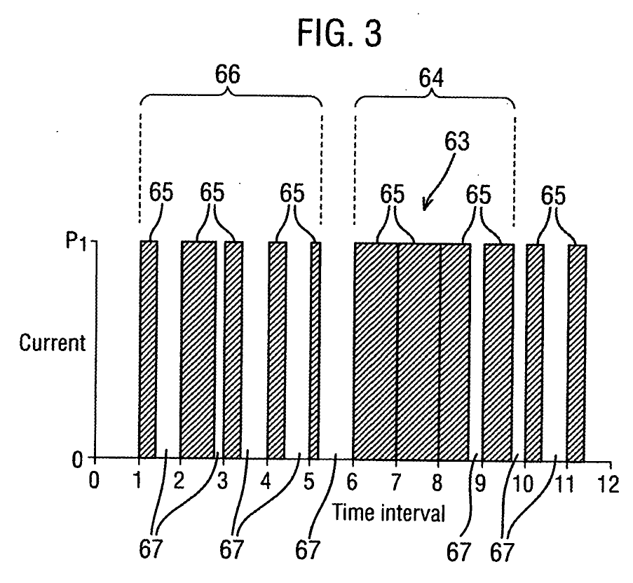

The micro-controller 50 further comprises a central processing unit (CPU) for implementing the program in dependence of the sensor signals 61 received from the temperature sensor 60 to produce appropriate electrical control or demand signals 63 to the switch circuit 51. To this end, the CPU compares the sensor signal 61 received from the temperature sensor 60 with the desired value required by the program, e.g. through use of the lookup table, and produces the time-varying, binary control signal 63 which accounts for the sensor signal 61. More particularly, the binary control signal 63 is a PWM control signal of fixed modulation frequency, e.g. in the range from 1 kHz to 200 kHz, but with a time-varying duty cycle depending on the sensor signal 61. An illustrative PWM control signal 63 is shown in FIG. 3.

As shown in FIG. 3, the control signal 63 is a continuous series of pulses 65 of direct current of common peak value P₁ having varying durations, i.e. the pulses 65 are interspersed with gaps 67 of varying duration. The electrical pulses 65 correspond to ‘logical-1’ or ‘switch-on’ segments of the binary control signal 63, while the gaps 67 correspond to ‘logical-0’ or ‘switch-off’ segments of the binary control signal 63. The “duty cycle” of the control signal 63 is the proportion of time that the control signal 63 is in its switch-on state. As will be recognised, this is determined by the pulse durations.

As further shown in FIG. 3, the duty cycle is time varying since the durations of the individual electrical pulses 65 are dictated by the temperature sensor signal 61. When a high heating rate is required to be delivered by the electrical heater 41 to the liquid substance 11 to maintain it at the desired constant temperature, for instance in the event of an endothermic event occurring in the liquid substance 11, the micro-controller 50 responds to the change in the sensor signal 61 to increase the duty cycle of the PWM control signal 63, e.g. as at region 64.

Conversely, when the heating effect of the electrical heater 41 needs to be reduced, for instance when an exothermic event occurs in the liquid substance 11, then the PWM micro-controller 50 reduces the duty cycle of the PWM control signal 63 in response to the sensor signal 61 indicating the consequential increase in temperature in the liquid substance 11 (see region 66) in order to maintain the temperature of the liquid substance 11 in essential isothermal manner.

Each switch-on segment 65 of the PWM control signal 63 corresponds to a period when the switch circuit 51 will be “closed” so as to enable the DC output signal 46 to be input to the electrical heater 41 for powering thereof. Conversely, the switch-off segments 67 of the PWM control signal 63 result in the switch circuit 51 “opening” to prevent the DC output signal 46 from being input to the electrical heater 41. It will be appreciated that the duty cycle of the pulsed DC input signal 65 to the electrical heater 41 matches that of the PWM control signal 63.

The switch circuit 51 is formed by a transistor, preferably a field effect transistor and most preferably a MOSFET. Where the switch circuit 51 takes the form of a MOSFET, preferably the MOSFET operates in enhancement mode.

In this embodiment, the switch circuit 51 is a n-channel enhancement mode MOSFET and the PWM control signal 63 is input to the MOSFET gate terminal, the DC output signal 46 is input to the source terminal, and the drain terminal is connected to the electrical heater 41.

The use of the switch circuit 51 amplifies the PWM control signal 63 since the DC output signal 46 is larger than the PWM control signal 63. For instance, in this embodiment the PWM control signal 63 has a current of 0.1 μA, while the DC output signal 46 has a current of 100 mA. In other words, the switch circuit 51 results in a current gain of 1×10⁶.

It will be further seen from FIG. 2 that the stirrer 30 incorporates a telemetry transceiver 70 linked to the micro-controller 50. The transceiver 70 is also connected to the electrical control circuit 40 such that it is powered by the DC output 46.

The telemetry transceiver 70 forms a wireless data link with an externally located telemetry transceiver 80. The wireless data link enables the program for the micro-controller 50 to be uplinked (or downloaded), e.g. from a computer. Additionally, the data signals representative of the DC input signals 65 to the electrical heater 41 are transmitted from the on-board transceiver 70 to the external transceiver 80. The external transceiver 80 then conveys this data to a data processor, for instance in a process controller, for processing to detect the exothermic and/or endothermic events in the liquid substance 11 during the isothermal power compensation calorimetry and to determine the amount of energy released/absorbed in such events.

The temperature signals 61 produced by the temperature sensor 60 may also be transmitted by the on-board transceiver 70 to the external transceiver 80, e.g. so that the real-time temperature of the liquid substance 11 can be displayed on a visual display.

To summarise, the IPCC method requires that the constantly stirred liquid substance 11 in the reactor vessel 5 be in an equilibrium state at a temperature higher than the base unit 1, e.g. at least 5 degrees Celsius higher. This is achieved by applying power to the liquid substance 11 by use of the heater 41 contained in the stirrer 30. In an ideal situation there is no, or minimal contact between the stirrer 30 and the walls of the vessel 5. The addition of a reactive fluid then initiates a chemical, biochemical or biological reaction, or process to start. If the energy of the system changes then the micro-controller 50 will accordingly vary the power output of the heater 11 to maintain the system in an isothermal state. If the reaction or process is endothermic then more power will need to be applied by the heater 41. Conversely, if the reaction or process is exothermic then less power will need to be applied by the heater 41. When the reaction or process is complete, a new equilibrium state will be achieved. By integrating the amount of energy change between the initial and final equilibrium states, the enthalpy of the reaction, or process, is determined.

In a second embodiment of the present invention, the stirrer 30 is supplemented with the components shown in dashed-line in FIG. 2, or modified so that these components replace the like components in the first embodiment. More specifically, the second embodiment of the invention has a light source 90, for instance of visible, UV or IR light, operatively coupled to a switch circuit 51′.

The light source switch circuit 51′ is operated by the PWM micro-controller 50 in the same way as previously described. In addition, the stirrer 30 incorporates a sensor 100 which senses changes in a condition in the liquid substance 11 effected by the emission of the light from the light source 90 of the stirrer 30. The sensor may, in this example, be an optical or chemical sensor, for instance a photosensitive element (e.g. a photodiode) or a pH sensor.

The sensor 100 produces an electrical sensor signal 101 which is input to an I/O pin of the micro-controller 50 for closed-loop control of the light source 90 in accordance with a program stored in the memory of the micro-controller 50.

In this regard, the micro-controller 50 may be programmed to cause the light source 90 to operate to produce a desired effect in the sensed condition, for example to maintain it at a constant value or to vary it in a time-dependent manner. Alternatively, the micro-controller 50 may be programmed simply to vary the intensity of the light emitted by the light source 90 until the sensor 100 detects a change in the sensed condition of the liquid substance 11, which change may indicate the initiation of a photo-chemical reaction by the light source 90, for instance indicated by a change in pH or a change in composition which alters the intensity of the light from the light source 90 received by the sensor 100.

Another alternative is that the micro-controller 50 operates responsive to the sensor signal 101 to cause the light source 90 to be varied to increase the yield of a certain reaction product in the liquid substance 11.

It will be appreciated that when the stirrer 30 is modified to incorporate the light source 90 and sensor 100 in place of the corresponding temperature control components 41,60, the system 10 need not form part of an IPCC.

Moreover, even when the stirrer 30 incorporates the temperature control components 41,60, whether with the light source 90 and sensor 100 or not, the system 10 also does not need to necessarily form part of an IPCC. For instance, the micro-controller 50 can be programmed to cause the electrical heater 41 to vary the temperature in the liquid substance 11 in accordance with a prescribed regime.

Where the stirrer 30 includes all of the components shown in FIG. 2, it will be understood that the micro-controller 50 can be programmed so as to produce PWM control signals 63,63′ which cause the heater 41 and light source 90 to operate to reach a common aim, e.g. onset of a specific reaction in the liquid substance 11, rather than achieving independent aims, which of course is also in the scope of the present invention.

Furthermore, it will be realised that the first embodiment of the invention can be modified to simply include the sensor 100 without the associated switch circuit 51′ and light source 90, for passive sensing of the condition in the liquid substance 11. In this connection, the sensor signal 101 could be transmitted over the wireless data link 70,80 for recordal or display. Conversely, in the embodiment in which the stirrer 30 incorporates the light source 90, associated switch circuit 51′ and sensor 100, the stirrer 30 may also incorporate the temperature sensor 60 without the associated switch circuit 51 and electrical heater 41. The temperature signal 61 could then be transmitted over the wireless data link 70,80 for recordal or display.

It will be further appreciated that the light source 90 and associated sensor 100 may be used passively, rather than actively. That is to say, the sensor 100 may take the form of a light sensor which detects the light emitted by the light source 90. As changes occur in a condition of the liquid substance 11 during mixing (and optionally heating), the amount of the emitted light detected by the light sensor 100 may vary accordingly. The changes in the liquid substance condition are represented by the varying light sensor signals 101 produced by the light sensor 100.

It will be yet further appreciated that other sensors and energy emitting elements can be incorporated in the stirrer 30 in place of, or in addition to, the combinations described above with reference to FIGS. 1 to 3.

It will also be understood that the magnetic stirrer 30 could have a number of alternative shapes under the bar-type banner, as known in the art. Moreover, the magnetic stirrer 30 may also have a cylindrical body, optionally with fins on the top, so that the secondary coil can be circumferentially arranged, either around the outside of the body or inside the body, as close as possible to the primary coil 17. The stirring magnets could then either be disposed inwardly of the secondary coil, or below the secondary coil.

While FIG. 1 only shows a single cavity 3 in the base unit 1, it will be recognised that the base unit 1 may provide a plurality of cavities 3, as shown in FIGS. 4 and 5. Thus, the base unit 1 can receive a plurality of reaction vessels 5 at the same time, each with its own stirrer 30. The temperature of the base unit 1 will be controlled in like manner to that previously described.

In FIG. 4 each cavity 3 is associated with its own primary coil 17, each primary coil 17 being connected to the power supply 15 (not shown). Thus, each stirrer 30 is inductively powered by its own primary coil 17. Moreover, the base unit 1 is adapted to produce a rotating magnetic field 21 under each cavity for rotation of the stirrers 30. In this manner, the stirrers 30 can operate independently so as to control the condition of the substance in the associated reaction vessel 5 in the manner hereinabove described.

In an alternative arrangement shown in FIG. 5, each stirrer 30 is inductively powered by a common primary coil 17 which extends underneath each cavity 3.

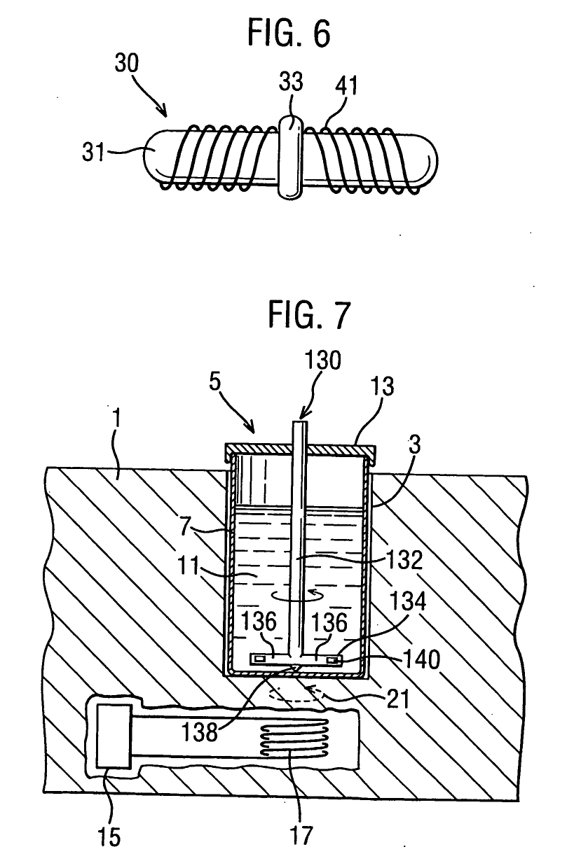

In FIG. 2 the stirrer 30 is shown to have the electrical heater 41 disposed internally thereof. However, as shown in FIG. 6, the electrical heater 41 may be disposed on the external surface of the body 31 of the stirrer 30, for instance taking the form of the illustrated heating coil 41 wound over the body 31. The ends of the coil 41 would sealingly pass through apertures (not shown) in the body 31 to the sealed interior and be connected to the switch circuit 51.

In FIG. 7 there is shown an embodiment of the invention which corresponds to that previously described with reference to FIGS. 1 to 3 other than the provision of a different stirrer 130 and a different configuration for the primary coil 17.

The stirrer 130 is still magnetically powered, but takes the form of a paddle-like stirrer. The stirrer 130 has a shaft 132, rotatably mounted in the lid 13 of the reaction vessel 5, and a stirrer head 134 having a two or more generally radially-directed arms 136 and an axially-arranged tip 138 about which the stirrer 130 rotates. The arms 136 have a magnetic structure 140 which co-operate with the rotating magnetic field 21 produced in the base unit 1 to cause rotation of the stirrer 130.

In contrast to the embodiment shown in FIG. 1, the primary coil is disposed underneath the cavity 3 in the base unit 1 rather than being wound about the cavity sides. A bar-type magnetic stirrer may be best with this arrangement.

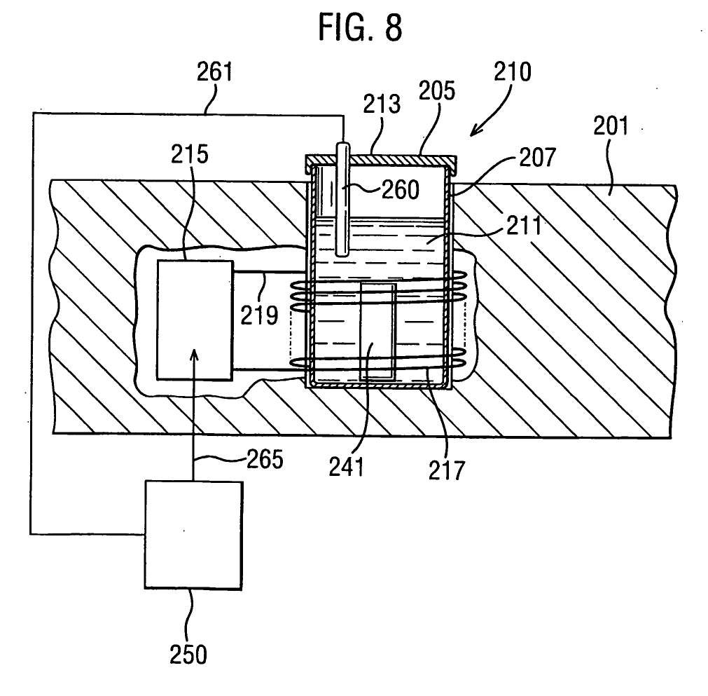

FIG. 8 shows an alternative heating system 210 according the present invention. In this version, the heating of the liquid substance 211 takes place through induction heating. Specifically, reaction vessel 207 receives a heater in the form of a block 241 of an electrically conducting material, e.g. graphite. The heating block 241 heats up by inductive coupling with the primary coil 217. To control the temperature of the liquid substance 211, the temperature is measured by a temperature sensor 260 which relays the sensor signals 261 (wirelessly or non-wirelessly) to a process controller 250. The process controller has a CPU (not shown) which operates to control the power supply 215 responsive to the sensor signals 261 so that the inductive heating of the heating block 241 by the primary coil 217 is controlled, for example varied to maintain the liquid temperature constant in the case of use as part of an IPCC.

Instead of a heating block 241, the induction heater may take the form of a magnetic stirrer into which is incorporated an electrically conducting material which is heated up by the induction effects of the primary coil 217. As an example, the magnetic stirrer may have a wire heating coil wound about its outer surface along the lines shown in FIG. 6.

Further alternative embodiments of the invention will be apparent from the ‘Summary of the Invention’ section supra and the appended claims.

It will be understood that the embodiments of the present invention hereinabove described with reference to the accompanying FIGURES of drawings are for illustration, and that the invention may adopt other guises and forms within the scope of the statements in the ‘Summary of the Invention’ section supra and the appended claims.

Finally, for the sake of certainty, the use herein of terms such as “about”, “substantially”, “generally” and the like in relation to a parameter or value encompasses the exact parameter or value as well as non-consequential variations therefrom.

This application claims priority from UK patent application No. 0 311 959.1 filed 23 May 2003, the entire content of which is hereby incorporated herein by reference.

What is claimed is:

1. An energy delivery system for delivering energy to content in a vessel, the system having:—
(a) a contactlessly-powerable energy emitting device which:—
(i) is adapted to be:—
positioned inside the vessel, and
contactlessly-powered when inside the vessel to emit energy to the content, and
(ii) has a control mechanism adapted in use to control the operation of the energy emitting device in accordance with a prescribed regime; and
(b) a power supply adapted in use to contactlessly-couple with the energy emitting device for powering thereof when inside the vessel.

2. The system of claim 1 wherein the energy emitting device is adapted to emit energy which, in use, affects a condition of the content and the control mechanism is adapted in use to operate to vary the amount of energy emitted by the device to control the content condition affected by the energy.

3. The system of claim 1 wherein the energy emitting device is adapted in use to emit thermal energy to the content.

4. The system of claim 1 wherein the device is a self-contained device.

5. The system of claim 1 wherein the energy emitting device is comprised in a stirrer.

6. The system of claim 5 wherein the stirrer is a contactlessly-drivable stirrer.

7. The system of claim 5 wherein the stirrer has an external casing defining a sealed inner volume inside of which the energy emitting device is located.

8. The system of claim 5 wherein the stirrer has an external casing which presents an external stirrer surface on which the energy emitting device, or an energy emitting part thereof, is mounted.

9. The system of claim 1 wherein the energy emitting device is electrically-powerable and the power supply is adapted in use to contactlessly provide electrical power to the device.

10. The system of any claim 1 wherein the device has an electrically-powerable energy emitting element which, in use, emits energy in response to electrical current provided thereto under control of the control mechanism.

11. The system of claim 1 wherein the device and power supply are adapted to be inductively coupled for powering the device.

12. The system of claim 1 which further has a base unit in which the vessel is holdable and which includes the power supply.

13. The system of claim 1 wherein the energy emitting device is comprised in a stirrer and said system further comprising a base unit in which the vessel is holdable and which includes the power supply, wherein the base unit has a contactless drive mechanism for contactlessly driving the stirrer.

14. The system of claim 1 wherein the control mechanism is able to vary the amount of energy emitted by the device.

15. The system of claim 1 in which the control mechanism has a pulse width modulation (PWM) controller for controlling operation of the energy emitting device.

16. The system of claim 1 wherein the control mechanism has a programmable controller which is programmed to cause the energy emitting device to operate in accordance with the prescribed regime.

17. The system of claim 10 wherein the control mechanism is an electrical control circuit operatively coupled to the electrically-powerable energy emitting element for controlling operation thereof in accordance with the prescribed regime.

18. The system of claim 17 wherein the control circuit includes a controller.

19. The system of claim 17 wherein the electrical control circuit is adapted to be contactlessly-coupled with the power supply for forming a contactless power transfer link.

20. The system of claim 1 wherein further comprising a sensor to produce condition signals representative of a condition of the content.

21. The system of claim 20 wherein the sensor forms a part of the energy emitting device.

22. The system of claim 20 wherein the sensor is a temperature sensor which produces temperature signals representative of the temperature of the content.

23. The system of claim 22 wherein the temperature sensor is adapted in use to be operatively coupled to the energy emitting device to control the device so that it regulates the temperature of the content.

24. The system of claim 20 wherein the sensor is operatively coupled to the control mechanism such that the condition signals are inputtable to the control mechanism and the control mechanism is adapted to control the amount of energy emitted by the device in response to the condition signals to regulate the sensed condition in accordance with a prescribed regime.

25. The system of claim 24, wherein the prescribed regime for the sensed condition is programmed in the controller.

26. The system of claim 10 wherein the device has a regulator operable to regulate the amount of power transferred from the power supply to the electrically-powerable energy emitting element and the control mechanism is operably coupled to the regulator to cause, in use, the regulator to regulate the power transfer so that the energy emitting element emits energy in accordance with the prescribed regime.

27. The system of claim 26 in which the operation of the regulator is controlled by control signals produced by the control mechanism in response to the condition signals.

28. The system of claim 26 wherein the regulator is a power-on/power-off switch for the electrically-powerable energy emitting element.

29. The system of claim 28 wherein the switch is a transistor.

30. The system of claim 29 wherein the transistor is a field effect transistor (FET).

31. The system of claim 10 wherein the control mechanism is adapted in use to operate to cause a continuous series of electrical pulses to be inputted to the electrically-powerable energy emitting element, the pulse durations and spacings being variable by the control mechanism to result in the energy emitted by the emitting element according with the prescribed regime.

32. The system of claim 28 wherein the control mechanism is adapted in use to operate to cause a continuous series of electrical pulses to be inputted to the regulator, the pulse durations and spacings being variable by the control mechanism to result in the regulator operating to control the energy emitted by the emitting element in accordance with the prescribed regime.

33. The system of claim 1 wherein the device has a transmitter.

34. The system of claim 1 wherein the device has a receiver.

35. An energy delivery system for delivering energy to content in a vessel, the system having:—
(a) a contactlessly-powerable energy emitting device which is adapted to be:—
positioned inside the vessel, and
contactlessly-powered when inside the vessel to emit energy to the content;
(b) a power supply adapted in use to contactlessly-couple with the energy emitting device for powering thereof when inside the vessel;
(c) a sensor adapted in use to produce condition signals representative of a condition of the content; and
(d) a control mechanism adapted in use to control the amount of energy emitted by the energy emitting device in accordance with a prescribed regime.

36. The system of claim 35 wherein the energy is such as to affect the sensed condition and the control mechanism is adapted to (i) receive the condition signals, and (ii) vary the amount of energy emitted by the device in dependence of the condition signals to regulate the sensed condition in accordance with the prescribed regime.

37. The system of claim 35 wherein the control mechanism is adapted to operate to control the amount of energy emitted by the energy emitting device by regulating the power transferred to the device.

38. The system of claim 37 wherein the control mechanism operates to control the amount of energy emitted by pulse width modulation (PWM).

39. A stirrer for stirring a fluid comprising an energy emitting mechanism which is adapted to be contactlessly powered to emit energy into the fluid.

40. The stirrer of claim 39 which is a contactlessly-drivable stirrer.

41. The stirrer of claim 39 wherein the energy emitting mechanism is adapted to be contactlessly-powered by electromagnetic induction.

42. The stirrer of claim 39 wherein the energy emitting mechanism has an electrically-powerable energy emitting mechanism which is contactlessly-powerable.

43. The stirrer of claim 39 comprising a control mechanism which is operatively coupled to the energy emitting mechanism for control thereof in accordance with a prescribed regime.

44. The stirrer of claim 43 wherein the control mechanism has a programmable controller programmed to cause the energy emitting mechanism to operate in accordance with the prescribed regime.

45. The stirrer of claim 44 wherein the controller is a PWM controller.

46. The stirrer of claim 42 wherein the electrically-powerable energy emitting mechanism has an electrically-powerable energy emitting element and the control mechanism has an electrical control circuit operatively coupled to the energy emitting element to control operation thereof.

47. The stirrer of claim 46 wherein the control circuit is adapted to be contactlessly coupled to an external power supply for forming a contactless power transfer link therewith.

48. The stirrer of claim 39 wherein the energy emitting mechanism is a microelectronic device.

49. The stirrer of claim 39 wherein the energy emitting mechanism is a heating mechanism.

50. The stirrer of claim 39 further comprising a sensor for sensing a condition of the fluid and producing real-time condition signals representative of the condition.

51. The stirrer of claim 50 adapted such that, in use, the energy emitting mechanism is controlled in response to the condition signals.

52. The stirrer of claim 51 wherein in use the condition signals are input to the control mechanism for processing thereof to produce a control signal for controlling operation of the energy emitting mechanism.

53. The stirrer of claim 52 wherein the control mechanism is adapted in use to control the energy emitting mechanism in response to the condition signals so that the energy emitted to the fluid is automatically regulated to maintain the fluid condition in accordance with a prescribed regime.

54. The stirrer of claim 43 wherein the control mechanism has a regulator for regulating the power input to the energy emitting mechanism and thereby regulating the energy emitted by the energy emitting mechanism.

55. The stirrer of claim 46 wherein the control mechanism is adapted in use to operate to cause the regulator to provide a continuous series of electrical pulses to the electrically-powerable energy emitting element, the pulse widths and spacings being such as to cause the energy emitting element to emit energy in accordance with the prescribed regime

56. The stirrer of claim 50 wherein the sensor is a temperature sensor.

57. The stirrer of claim 39 comprising a transmitter and/or a receiver.

58. A laboratory-scale reaction apparatus comprising the system of claim 1.

59. A calorimeter comprising the system of claim 1.
